(19) United States
(12) Patent Application Publication
(10) Pub. No.: US 2013/0166657 A1
(43) Pub. Date: Jun. 27, 2013

(54) E-mail Systems

(71) Applicant: Saied Tadayon, Potomac, MD (US)

(72) Inventor: Saied Tadayon, Potomac, MD (US)

(21) Appl. No.: 13/338,226

(22) Filed: Dec. 27, 2011

(51) Int. Cl. G06F 15/16

(52) U.S. Cl. 709/206

(57) ABSTRACT

Here, we are providing solutions to improve the performance of email systems in different aspects, e.g. in terms of reliability, efficiency, redundancies, safety, security, and convenience for the users. The system can be on a computer, PDA, tablet computer, phone, smart phone, electronic device, game device, e-book reader, game console, communication device, computing device, PC, server, terminal, kiosk, video game, entertainment device, multimedia device, movie player, or calendar device. Other than the email, these teachings also apply to SMS, MMS, XMS, and texting. Various applications and examples are given.

### BACKGROUND

Email systems are extremely useful for communication between people around the world. However, they have some shortcomings that we address here in this disclosure, to improve those systems.

### SUMMARY

In this disclosure, we are providing solutions to improve the performance of email systems in different aspects, e.g. in terms of reliability, efficiency, redundancies, safety, security, and convenience for the users. The system can be on a computer, server, distributed or cloud computing, PDA (personal digital assistant), tablet computer, phone, smart phone, electronic device, game device, e-book reader, game console, communication device, computing device, PC (personal computer), server, terminal, kiosk, video game, entertainment device, music box, music player, multimedia device, movie player, calendar device, watch, clock, or the like.

The email in this invention and the corresponding teachings can be generalized and applied to cover (and include) SMS (Short Message Service), MMS (Multimedia Messaging Service), XMS (Extended Messaging Service), texting, voice message, multimedia message, video message, combination message, live messaging, instant message, chat session, blog, social media forum, voting forum, discussion forum, consumer forum, or the like, in which a message or information or data is transmitted or sent or pushed or pulled or downloaded or uploaded from or between point A and point B or 2 or more people or computer units or terminals, automatically (e.g. by a computer, microprocessor, or processor), based on a trigger or event, semi-automatically, or manually, e.g. by a user or a third party, acting on it, e.g. by pushing a button or choosing a menu item on the screen or display or monitor.

### BRIEF DESCRIPTION OF FIGURES

Here are some examples/embodiments:

FIGS. 1(a), (b), (c), and (d) show an embodiment of the invention for the system of conditional and rule-based emails.

FIG. 2 shows an embodiment of the invention for the flow chart or method for conditional and rule-based emails.

FIG. 3 shows an embodiment of the invention for the flow chart or method for conditional and rule-based emails.

FIG. 4 shows an embodiment of the invention for the flow chart or method for automatic email list adjustment.

FIG. 5 shows an embodiment of the invention for the flow chart or method for updating email addresses.

FIG. 6 shows an embodiment of the invention for the flow chart or method for email protection.

FIG. 7 shows an embodiment of the invention for the flow chart or method for using templates.

FIG. 8 shows an embodiment of the invention for a system for automatic email list adjustment.

FIG. 9 shows an embodiment of the invention for a system for updating email addresses.

FIG. 10 shows an embodiment of the invention for a system for email protection.

FIG. 11 shows an embodiment of the invention for a system for using templates.

FIG. 12 shows an embodiment of the invention for various functions and applications.

### DETAILED DESCRIPTION OF THE EMBODIMENTS

In this disclosure, we present multiple solutions through multiple embodiments, with various features and parameters. Please note that the examples can be combined together, and their features can be added, mixed, or combined together, to produce hybrid or combination solutions between various examples, modules, parts, systems, or subsystems. So, the following systems are just some examples to teach various aspects of the invention, and any combination or mixture of the examples or subsystems is also a part of the teaching here, for more comprehensive solutions, to improve the shortcomings of the email systems, for different aspects.

The hardware can be (or on) any platform or device available, e.g. on a computer, PDA, tablet computer, phone, smart phone, electronic device, game device, e-book reader, game console, communication device, computing device, PC, server, terminal, kiosk, video game, entertainment device, music box, music player, multimedia device, movie player, calendar device, watch, clock, or the like.

### Automatic Email List Adjustment:

In an email system, when person A wants to send an email to person B or a group of people, the system warns of any wrong recipient, to be deleted from the list of recipients, based on the subject or past history of emails for all or just the user, based on histogram or statistical analysis (or generally, pattern recognition). In addition, the system suggests possible other recipients that fit the list of recipients or can be associated with such emails, so that sender A may choose to add them to the recipient list.

For example, assume person A most of the times sends email to persons B, C, D, E, and F, for example, on a specific subject (e.g. John's birthday or birthday) or on a specific dates, e.g. his birthday e.g. on December 3, or on Christmas days, or just last Christmas day, or Sun nights, e.g. after 7 pm local time. Now assume person A wants to send an email to all these recipients, but forgets to include recipient C. The email system could detect that C is usually included with B, D, E, and F, in say, e.g. 89 percent of the times (which is more than a threshold, e.g. 50 percent, to make such a distinction or determination), to warn person A. Therefore, it proposes adding C to the recipient list. In the same example, if person A sends an email to B, D, E, F, and G, the email system could interfere and stop the transmission, to warn user A of an unwanted or possible unwanted recipient, so that user A has a choice to correct the mistake and remove recipient G from the email list, if it was not intended that way (or keep the list, if it was really intended that way).

In one embodiment, the email system does all the editing, adjustment, addition, or subtraction to the email list automatically, without asking the user for any approval or confirmation. In one embodiment, the email system does all the editing, adjustment, addition, or subtraction to the email list, after asking or suggesting the user for some possibilities, with prior approval or confirmation from the user, e.g. after interacting with the user and getting feedback from the user, e.g. using a dialog box on computer screen.

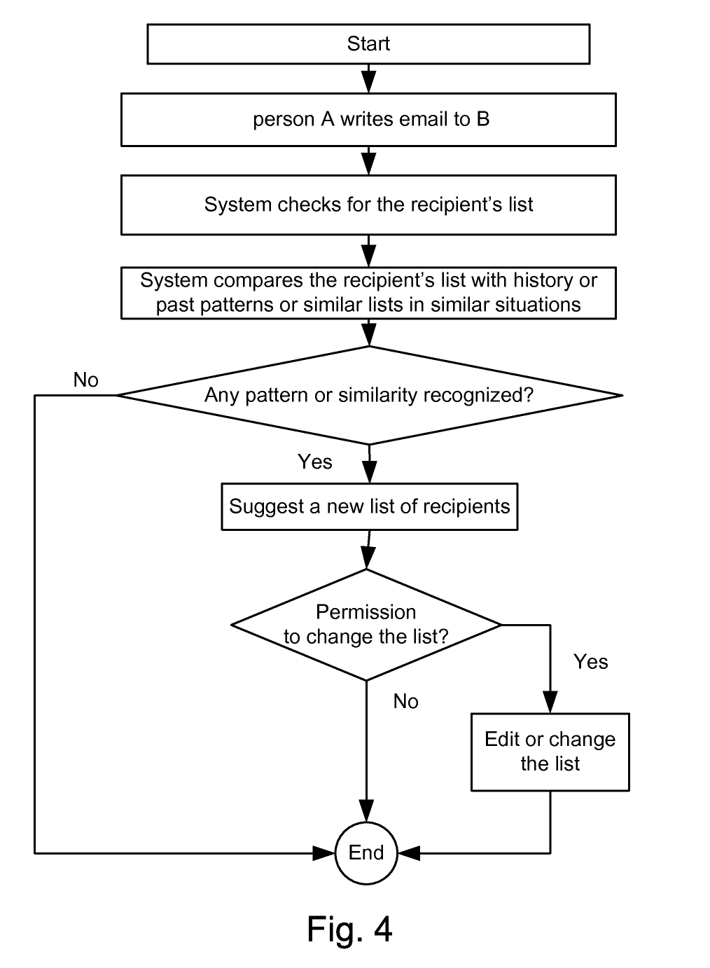

An embodiment for a system changing or editing the recipients' list automatically, with history or past pattern comparisons, plus user's permission to change or edit, is shown in FIG. 4.

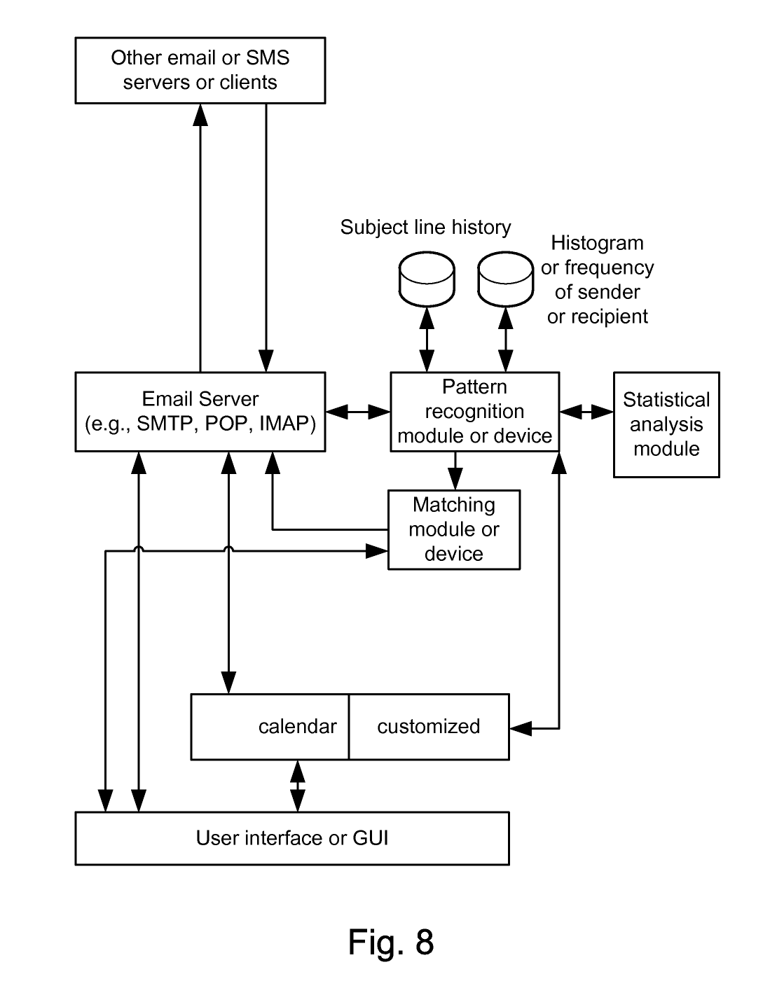

An example of the system is also shown in FIG. 8, with statistical analysis and pattern recognition, based on customized calendar and histogram or history of the patterns or data for prior emails, to find the potential candidate for the email list or grouping (as a match or potential match), for the system to present the candidate(s) to the user(s) for the approval(s), and then incorporation of the suggestion(s) into the email, if approved by the user (using e.g. a graphical user interface (GUI)).

Another example is a method for adjusting email or message recipient list, in which the email system receives an email or message from a user's device or user interface. It finds the list of recipients from the email or message (e.g. stored in a memory device). The classifying device categorizes the email or message into different groups or classes, based on one or more of the following items or parameters:
subject line of the email or message,
one or more keywords in content of the email or message,
frequency or histogram of one or more words or phrases in content of the email or message,
history or patterns of prior emails or messages,
time and date of the email or message,
a flag or tag corresponding to the email or message,
type or content of one or more attachments of the email or message, if any,
name of one or more attachments of the email or message, or
the creator of the email or message.

Then, it compares the list of recipients with the recipients' list from emails or messages belonging to the same group or class (e.g. stored in another memory device). If the 2 lists are different, then it presents the differences to the user, to observe and verify. Then, based on the user's verifications, the email system or the controller or the processor or the CPU automatically changes or edits the list of recipients (e.g. addition or deletion of names or addresses).

In one embodiment, the calendar is customized based on dates related to locality, personal dates, important events, public dates, or dates associated with friends or social group. The calendar is accessed for marked or highlighted dates or events. In one embodiment, the user's device or user interface comprises security, verification, confirmation, biometrics, sign-up, or authentication module. The notification module warns or notifies the user that e.g. the list of recipients is missing one or more names or addresses, or has one or more extra names or addresses. In one embodiment, the system displays a dialog box on display or monitor for the user. The system gives multiple choices to the user, through dialog box or menu. The system calculates a score or probability for matching. The matching module is trained based on prior matches, samples, and decisions (e.g. stored in training storage or database). In one embodiment, the system combines one or more calendars in to one aggregate calendar. The system compares the list of recipients with a forbidden recipient database, to prevent the email or message to reach a wrong person, by mistake.

### Updating Email Addresses:

In an email system, once user A has a new email address (or add, change, or delete an account or email address, or legal name change, or user name change), the change is reflected in all of the groups and lists containing that email address automatically, for himself or for another user, without human intervention, for more security, accuracy, and convenience. Thus, the system searches for the same string of characters (e.g. pattern recognition or string matching) or nicknames or abbreviations or substitute names, to find and automatically replace all the instances (in one example), or in one embodiment partially replaces some of the instances, or in one embodiment asks for the confirmation of the user to replace each instance one at a time, from the database, list, group, subset, or set(s).

The adjustments and comparisons for matching is exactly 100 percent search match or string match for characters or letters or names, in one example. In one embodiment, the match is based on confidence level or probability, below 100 percent, or partially, e.g. above a threshold, e.g. above 80 percent probability or match, e.g. when at least 80 percent of characters are matched with the original name, e.g. character by character comparison, to account for misspelled names or possible mistakes in entering the names by the user, to cover those situations.

The forwarding or replacements can be permanent or temporary, e.g. for or based on a date or date range, e.g. for today or month of January 2011, set by the user.

In one embodiment, the user can enter a name or email address, e.g. as JohnXXX@yahoo.com, or John123@X.com, or JohnX, or JohnX@X.X, or JohnX@Y.Z, or John.X@yahoo.com, to be replaced with a specific name or a range of names or formulation of multiple names or template(s) or substitutions or identifiers or addresses or the like, where X, Y, and Z are wildcards or placeholders for zero or one or more characters, or N characters, or unlimited characters, where N is an integer larger than one.

Some examples are shown below:

Example 1:

John456@yahoo.com, John45@yahoo.com, and John123@yahoo.com are all converted to or replaced with (or mapped to) JohnSmith@google.com.

Example 2:

John456@yahoo.com, John45@yahoo.com, and John123@yahoo.com are converted to or replaced with John456@google.com, John45@google.com, and John123@google.com, respectively.

Example 3:

John456@yahoo.com, John459@yahoo.com, and John123@yahoo.com (but not John45@yahoo.com or John4544@yahoo.com) are all converted to or replaced with (or mapped to or forwarded to) JohnSmith@google.com.

Example 4:

John456@yahoo.com, John45@yahoo.com, John, and John@google.com are all converted to or replaced with (or mapped to) JohnSmith@google.com.

Example 5:

John456@yahoo.com, John45@yahoo.com, and John123@yahoo.com are converted to or replaced with John456@yahoo.org, John45@yahoo.org, and John123@yahoo.org, respectively.

Example 6:

John.Smith@yahoo.com is converted to or replaced with (or mapped to) JohnSmith@google.com.

Example 7:

John.Smith@yahoo.com is converted to or replaced with (or mapped to) Joe.Smith@google.com.

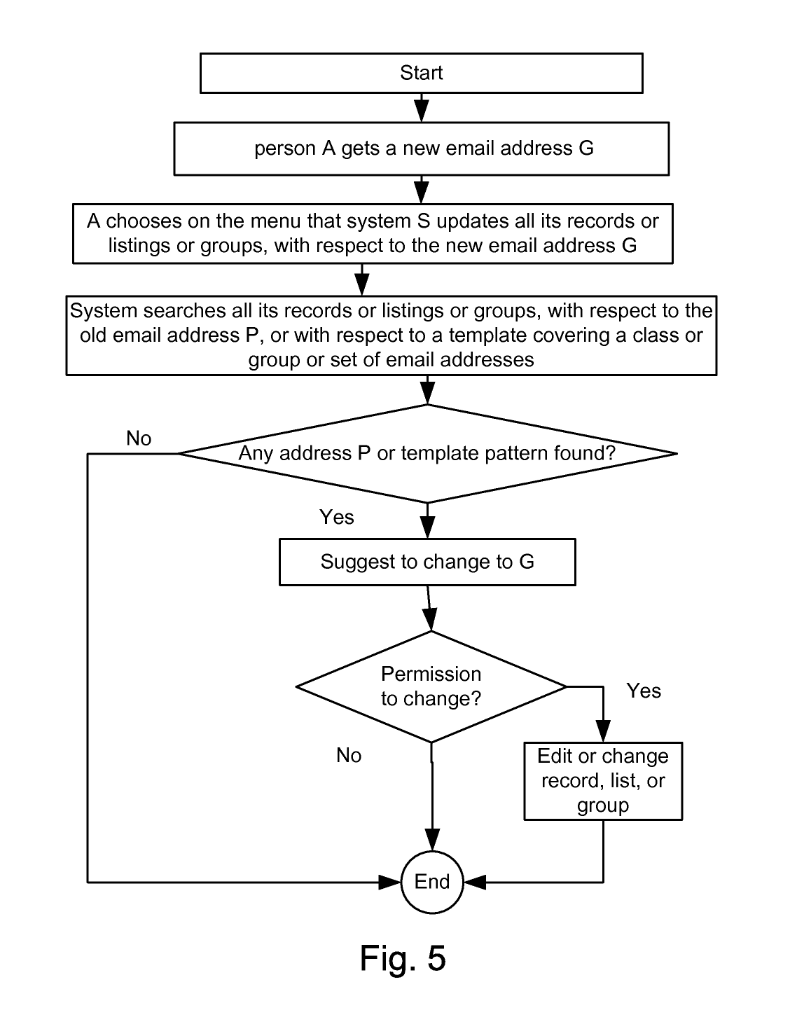

An embodiment for a system changing or updating email addresses automatically (using address or template pattern), with user's permission to change or edit, is shown in FIG. 5.

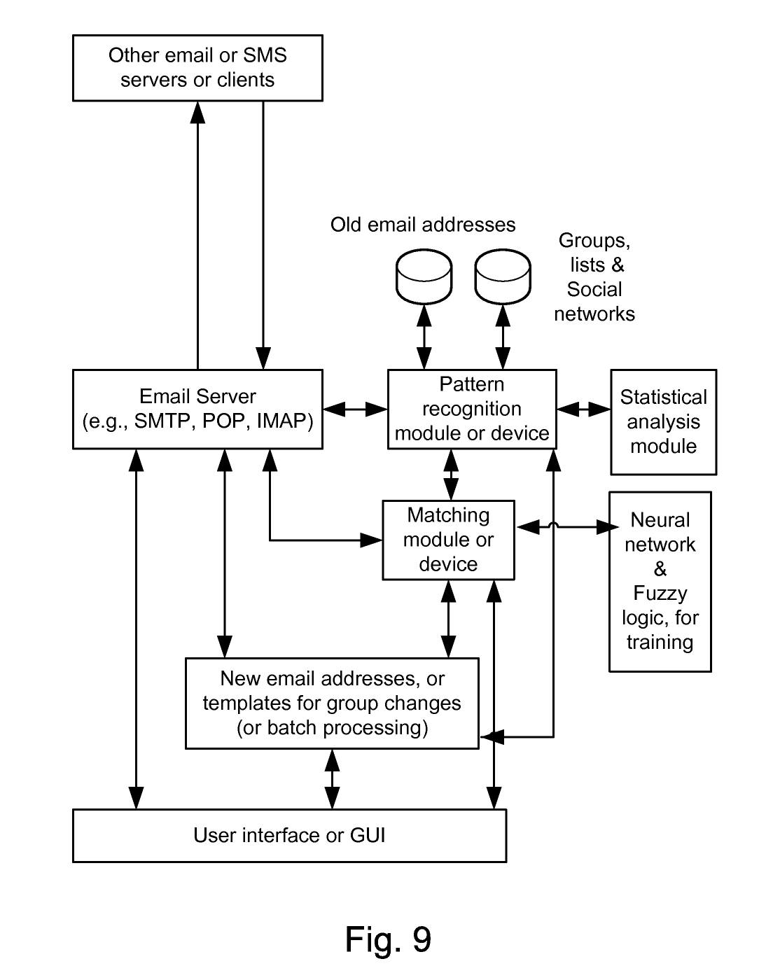

FIG. 9 also shows an example of a system for single or multiple email address update (e.g. using template or batch processing), for all old emails or groups or listings (in which the user or the email owner was (or is) a member of), using a matching module or device (which includes or connects to a pattern recognition module, statistical analyzer module or device, neural network module, and Fuzzy Logic module or device (e.g. for training purposes, from history, or old data or emails, or patterns observed or obtained in the prior emails)), to change or update the email addresses, accordingly.

### Conditional and Rule-Based Emails, Based on the External Sources or Events:

Here, we give an example of a queued email. Person A (the sender, or user A) wants to send an email to person B (the receiver, or user B), but the email goes to a queue, waiting to be sent to user B automatically, sometime in the future, in a predetermined time interval, or based on a trigger or an event. This is useful when user A wants to prepare an email to be sent to user B, but user A does not want to send the email right away, since e.g. it may not be the right time to send the email. A few examples below demonstrate the usage of such email feature:
a) An example may be birthday message that user A has prepared for user B's birthday. Such email needs to stay in the queue and be sent to user B only on user B's birthday, which is triggered by e.g. a date and hour extracted from user B's contact information or set by the user A (for example as B's birthday date), on a calendar (e.g. automatically, using a calendar on the computer, phone, or connected to the email system) or using a clock on a computer or communication device, such as smart telephone or tablet computer.
b) Another example could be when user A wants to send a congratulation email to user B for his favorite baseball team X winning the playoff User A could prepare such email for user B but set the delivery conditional upon user B's favorite team winning the game. The system should keep the email in the queue and send it to user B only upon confirmation of baseball team X winning the play offs. This confirmation can be done manually by the user A or his proxy friend, or can be sent by a news feed or computer analyzing the result of the baseball games, automatically, or using a flag or variable for such a designation, e.g. in a template (for ease of programming and designation by the user, and also for the interpretation by the system, to understand the value of the variable, as to the identity of the winning team). In one embodiment, multiple emails can be set for multiple teams, congratulating different teams, if they win. So, only one email is generated, based on the condition for that winning team being satisfied (but not for other teams (that lost)).
c) Another example is when user A wants to send a response email to user B, when it receives another specific email, such as an email from a specific person with a specific subject. The system should keep the email in the queue and send it to user B only when that specific email is received, as the trigger event, with a variable or flag set to activate and send the stored email in the queue or storage or memory unit. In such an embodiment, the condition, for example, for releasing the response email, is evaluated upon receiving the incoming emails, based, for example, on the subject and the sender's identity, specified in that email, as a trigger or flag or identifier for a variable or parameter.

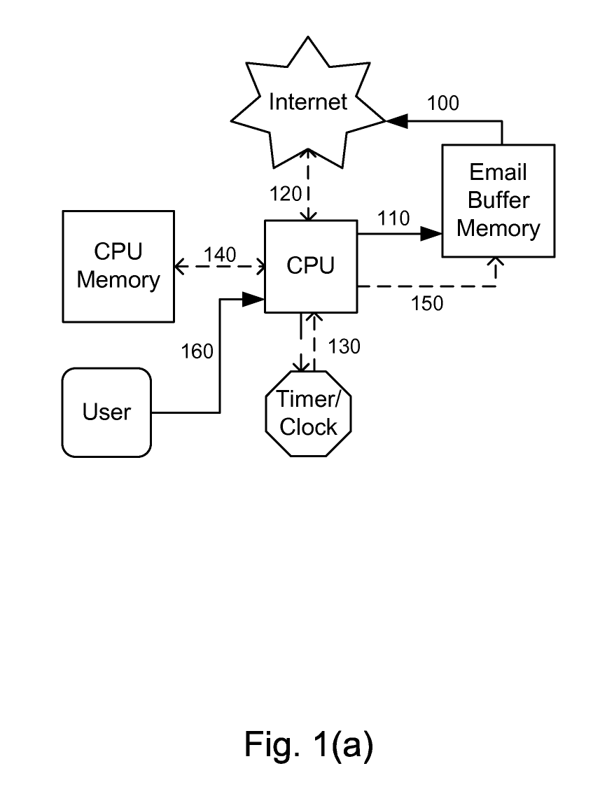

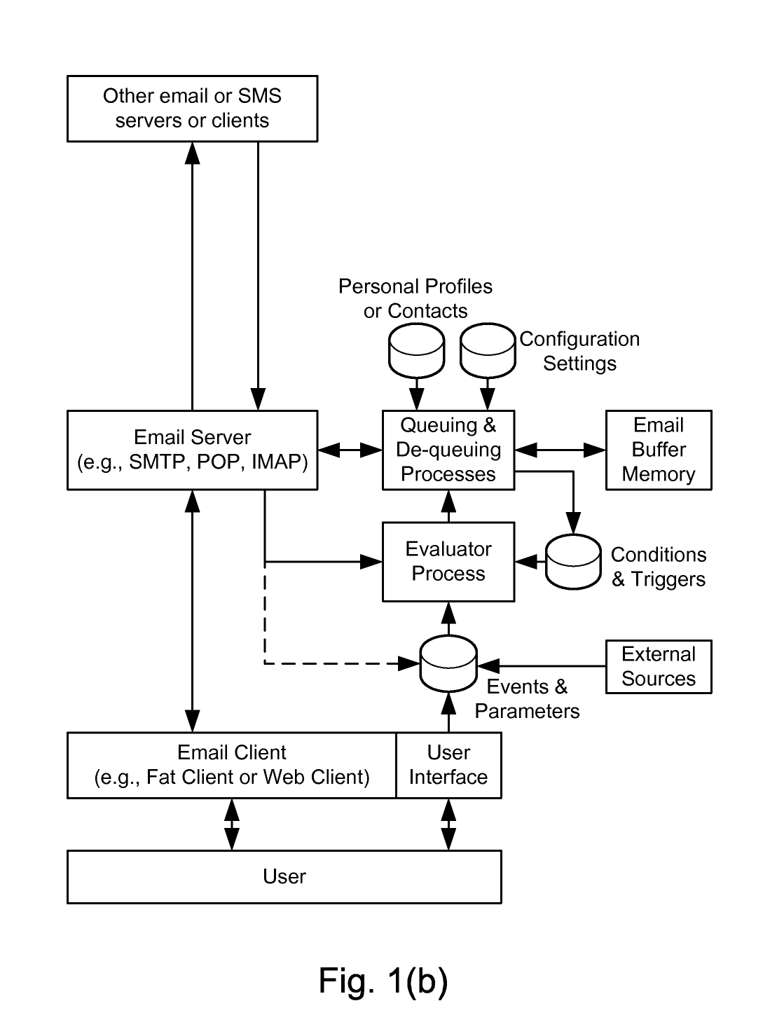

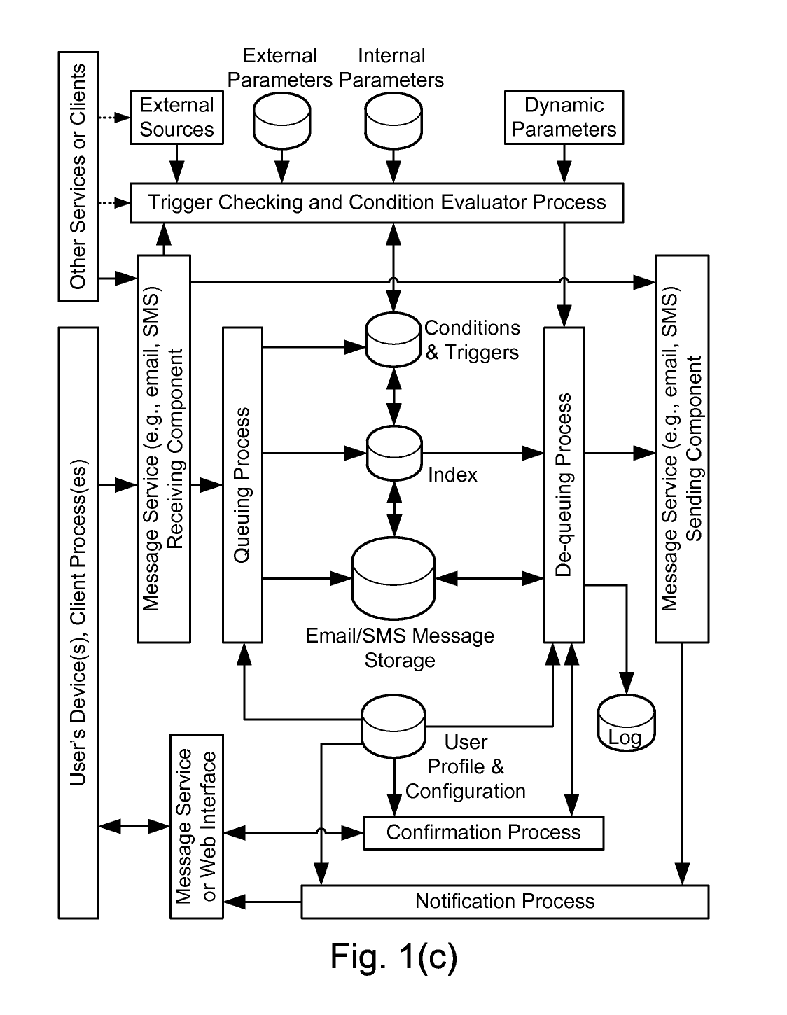

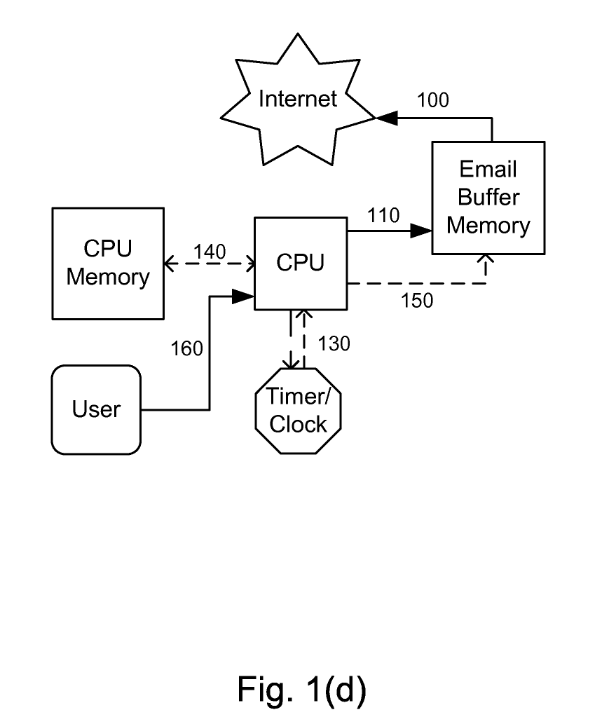

In one embodiment, as for example depicted by FIG. 1(a), an email or message is sent by user (160). In one embodiment, the email is received by an email or messaging server or processor(s) (denoted as CPU in FIG. 1(a)). In another embodiment, the user's device or processor(s) is denoted as CPU in FIG. 1(a). Instruction and data are exchanged between CPU and CPU memory (140). CPU stores (110) the email or message for a later time/interval, or until a condition is satisfied in an email buffer/memory. The buffer may, for example, be based on file system or database.

In one embodiment, the CPU receives or retrieves (120) (either push or pull methods) event information from an external source (e.g., Internet), or an internal source, or it evaluates conditions based on a timer/clock by, for example, checking or receiving (130) the system time/date. Upon analyzing the events and evaluating conditions, the CPU releases the email or message for delivery or sending, for example, by providing a command (150). Then, the stored email or message is sent to its recipient, for example, by sending it to other email server(s), accessible via connection to the Internet or a local or a private network.

Here are the components of the system described above, as an example:
100: Email leaving the system to the Internet
110: Email stored by CPU, for a later time
120: Event Information retrieved from the Internet
130: CPU checking the timer/clock, or other internal conditions, e.g. checking the calendar or user's notebook or file, e.g. from a database
140: Instruction and data exchange between CPU and CPU memory
150: Email release command from CPU
160: Email sent by user

In one embodiment, as depicted for example by FIG. 1(b), the queuing of the email sent by a user is done, for example, at the email service provider. In one embodiment, the user sends an email, via an email client running on a user's device. The email client may be a fat client (e.g., capable of an email protocol such as POP or SMTP) or a web client (e.g., communicating with email server via HTTP or HTTPS). In one embodiment, the email server receives the email sent by the user and determines that the email should be queued.

In an embodiment, an email header (e.g., metadata set by the email client, or a flag set via interface to the web mail server) is used to indicate that the email should be queued. In one embodiment, the email service passes the email to a queuing process which determines the condition or triggers associated with the email, e.g., by inspecting the metadata. In one embodiment, the queuing process determines the condition as a date, for example, defined as B's birthday. A process then extracts B's birthday from a personal profile and contact database, and sets the condition of the release to be the extracted date. The information can also come from a search engine or data-mining module searching personal files, Internet, or internal or external databases.

In one embodiment, the evaluation of the parameter(s) associated with a condition (e.g., a birthday date) is made at the time the condition is constructed. In one embodiment, the parameters of the condition are extracted during an evaluation of the condition to determine if the condition is met. Such an embodiment is useful, for example, when such parameters are dynamic and change over time. The condition or trigger is created and stored, for example, in a database or a table. In one embodiment, a user interface is provided for the user to select a calendar event to associate with an email.

In one embodiment, a calendar event's identifier is included in the metadata to reference the associated calendar event. In one embodiment, during evaluation of the condition associated with the email and the calendar event, for example by an evaluator process, the calendar's identifier is used to determine or extract the date from the calendar event. Such an embodiment allows the condition to be evaluated correctly (i.e., in track with the calendar event object), even if the calendar event is modified in the meantime (e.g., when a user changes the event's date). In one embodiment, a cross table is used to make association between various condition parameters (e.g., the calendar event entries) and the stored conditions/triggers. In one embodiment, such a cross table is used for checking for the existence of the objects (e.g., a calendar event object referred to by its identifier), which hold the values of condition parameters, when evaluating the conditions or when running a housekeeping cleanup tasks on the stored condition and trigger database or table.

In one embodiment, the queuing process stores the email in an email buffer or memory, in a database, file system, or a file, for later extraction. An evaluator process, for example, running as a batch or background process on a server or computer, evaluates the stored conditions and triggers. Once a condition or trigger is satisfied, the evaluator process sends a message or triggers a de-queuing (reverse of queuing (or releasing or sending out)) process to release the email from the storage (e.g., buffer or memory). In one embodiment, the de-queuing process updates the entries (e.g., status) in the condition and triggers and the database holding stored emails.

In one embodiment, the de-queuing process releases the email to an email server for sending it to recipient(s), e.g., by sending it to other servers or clients. In one embodiment, the evaluator process periodically runs through the conditions and triggers to evaluate them. In one embodiment, the evaluator evaluates each condition periodically, with a minimum time interval between each evaluation. In such an embodiment, the evaluations of the conditions are staggered between multiple runs of evaluator process. In one embodiment, the conditions to be evaluated are staggered in groups. In one embodiment, when a condition is met, e.g., evaluated to be true (for example, the current date is B's birthday), the evaluator process provides the condition identifier or the email identifier (or index) associated with the condition to the de-queuing process.

In one embodiment, the de-queuing process is decoupled from the evaluation process. In such an embodiment, the communication between the processes may be done, for example, by setting/reading/filtering flags and/or entries in tables accessible by both processes. In one embodiment, the evaluator process updates the value of condition in the condition and triggers database. In one embodiment, the evaluator process enters the condition's or trigger's identifier associated with the satisfied condition, in a table or database. In one embodiment, the de-queuing process reads such table to determine the satisfied conditions, and determines the associated emails (via their identifiers and indices).

In one embodiment, such determination is performed by the evaluator process which then enters the email identifiers in a table for the de-queuing process to read. In one embodiment, once the de-queuing process reads or determines the email identifiers associated with satisfied conditions, it provides the email identifiers or the emails from the email buffer or memory to the email server for further processing. In one embodiment, the de-queuing process deletes the de-queued emails from the buffer (or marks them for deletion, in order to be deleted later by a housekeeping or archiving task or process). In one embodiment, the de-queuing process removes the conditions or triggers, previously constructed for the processed email.

In one embodiment, the evaluator process uses system resources, such as time/date, through function calls or APIs, to evaluate a condition based on current date or time. In one embodiment, a condition or trigger object refers to parameters set by user (e.g., through a user interface) or external sources. For example, in one embodiment, events or parameters may be in a shared community database, where one or more users may set the values of the parameters or events. For example, a parameter indicating whether baseball team X has won the playoff may appear as tuple having an expression “baseball team X has won the playoff” and an associated truth value as “true”, “false”, “undetermined” or a fuzzy logic value. Such tuple may be presented to a user or users in a user interface (e.g., an interactive web page) for setting its truth value. A process such as a search engine or news feed may be used to evaluate and set the truth value. Other parameters may be set to other values or expressions, depending on the context. These parameters and events are used by the evaluator processor module to evaluate conditions and triggers, based on the values of such parameters and events. In one embodiment, new parameters or events tuples are generated by parsing the metadata from the email, for example, by the queuing process. Such parameter or event tuples are stored in a database or table and are associated with the condition object, e.g., via a cross table.

In one embodiment, the evaluator process is invoked or triggered via receiving an email or message from user B, as in example (c) above. In such an embodiment, user A's email or message is stored in an email buffer or memory. Upon receiving user's B message or email, for example, by the email server, the metadata and fields of the message (for example for subject line and sender) are analyzed to determine if a condition is met to release user A's response email or message already in the email buffer or memory. The analysis of the metadata may be done, for example, by the email server, an analyzer process, or the evaluator process, in various embodiments.

In one embodiment, the email server (or the analyzer processor/process) and the evaluator processor/process are decoupled. In such an embodiment, for example, the analysis results are placed in a storage, e.g., by updating the events and parameters database or table, for the evaluator process to read at a later time. In one embodiment, when the evaluator process determines that the condition for releasing A's stored email is satisfied, it signals or triggers the de-queuing process or updates a status on the condition of its associated email for the de-queuing process to remove the stored response email or message and send it to the recipients(s) via an email service.

In one example, for all of the above, the identity of the user, as an authorized person, can be verified using biometrics, password, PKI module, a security system, an authentication system, or the like, attached or connected to the system described above.

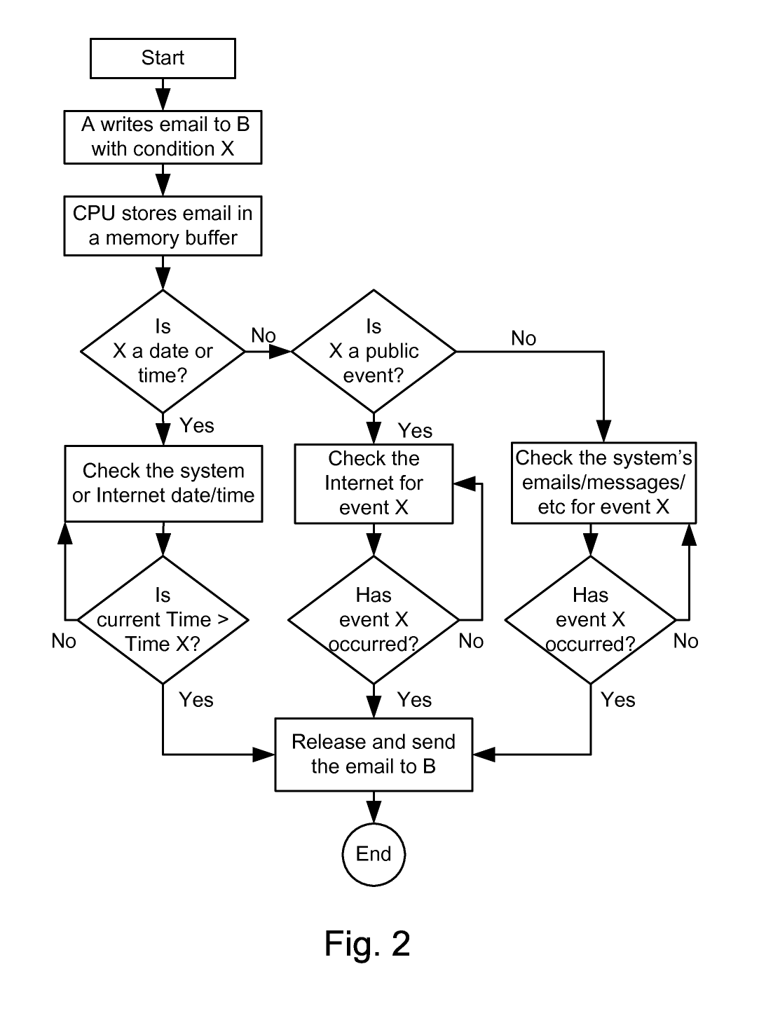

As shown in FIG. 2, the system checks for date/time, events, and messages (or internal notes, conditions, parameters, or settings), to verify if the event has occurred to release or send the email to person B, the receiver.

Now, we give an example of a delayed email. In an email or messaging system, person A initiates the steps to send an email or message to person B. However, there is a buffer in between, for example in the server, for which the email sits e.g. for 5 minutes, before going out toward the destination, person B. The 5 minute period is set by the user or administrator. The 5 minute waiting period lets the person A to recall or cancel the message or email, before leaving the email server. This is useful when a person may change his/her mind, and he/she wants to stop his/her email, or cancel/edit/tone down his/her message, as a cooling-off period. The 5-minute period can be a default on the system, or customized by the user, or a variable on the menu. In the following different example cases, provided in one or more embodiments, after (for example) the 5-minute period:
(a) person A is asked by the system if the email can go out now, to get the confirmation for sending the email, from the sender, e.g. through a pop-up menu on screen of computer or telephone set display.
(b) the email is sent out automatically, without any question or conformation from the sender. A notification message is also returned to user upon sending out the email, in one embodiment.
(c) the email requires confirmation, unless it is tagged or flagged as “urgent” by the sender (person A), in which case it goes out automatically, without confirmation. This can happen after the 5-minute period, or immediately after the email is sent without waiting for the 5-minute period.

In one embodiment, as, for example, depicted in FIG. 1(d), an email is sent by user (160) and it is stored (110) by CPU, controller, processor, or microprocessor, for a later time in an email buffer or memory or storage or queue. Instruction and data exchange (140) between CPU and CPU memory. CPU checks or receives (130) the timer/clock information, to evaluate whether the hold time for the email is over. The user may recall the sent email in the meantime, and the CPU removes the stored email from the email buffer or memory. If the email has not been removed or tagged for removal (e.g., as the result of user's recalling the email), upon determination that the hold time is over, the CPU provides an email release command (150) to send (100) the stored email to recipient(s), for example, by sending the email to email clients or servers in the network (e.g., in or via Internet).

An embodiment, as for example depicted in FIG. 1(c), handles delayed emails and queued emails. The external and internal sources and parameters (such as who or which team won at the final or championship game, or if the value of a stock for a specific stock went over (or below) a threshold, e.g. 25 dollars) supply information to the trigger checking module or device, so that it checks against the conditions to see if the message that was waiting in the queue should be released or deleted or still remained in the queue. The confirmation module or device confirms with the user, and notification module or device notifies or warns the user, about the process and status of the message or email. All processes and modules or devices in the figure are optionally connected to one or more Logs, to record the history and make a log or listing of all events and decisions. If it is decided (from the above) to release the email (to send to recipient), the message or email goes through the de-queuing module or device or processor, to be sent by sending component, device, module, or processor.

For conditions or applications that require the position of the user or device, the conventional triangulation method can be used to find the device or user, or a GPS device can be added to the system, e.g. connected to the user's device or trigger checking device or module. In one embodiment, a configuration setting stored, for example, in a file, table, or database, is used to construct the condition.

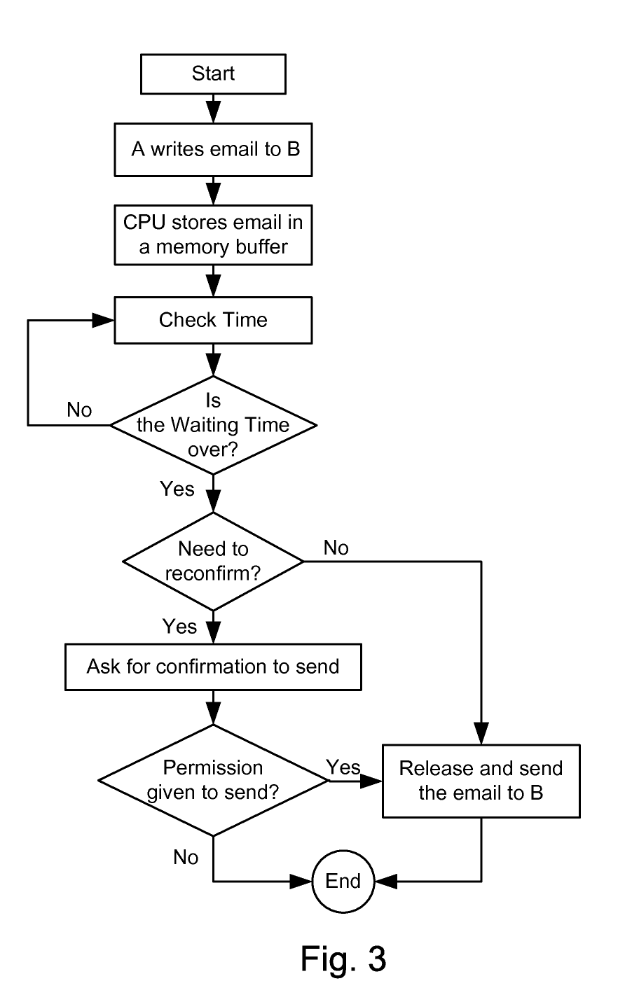

In FIG. 3, we have one embodiment in which the condition is based on a time or time period or event, e.g. birthday of a person or New Year Day. After the condition is satisfied, if the user or administrator required a confirmation, the system asks for a permission or reconfirmation from the user, before releasing and sending or forwarding the email to the recipient(s). If the permission is given by the user, the email will be sent to the recipient(s).

In one embodiment, the delay time and the actual sending time are recorded in the header for the email, and can be also displayed on the email, for receiver to view, as one option, if the user set the parameters that way (on the menu of choices for the emails).

### Email Protection:

In an email system, person A sends an email to person B, and tags that as “extremely important”, as a flag or part of the header, so that the email system does not let person B (e.g.) ignore and delete the email, and so that person B needs a password or PIN or smart card or biometrics (with needed hardware attached to the system, e.g. for biometrics reading/verification, or keyboard/processor/database for entering/analyzing the password), to be able to delete or remove or save or archive or forward the file or email or attach a file to the email (or do other actions on that email), with an optional acknowledgment sent back to the original sender, by e.g. another email. This also can be used for opening or reading the email or file.

This also helps preventing accidental deleting or forwarding of an email or file attachment for very important emails or files by the receiver. For example, the dialog pops up, to ask the receiver if she really wants to delete or forward the file or email, and/or (as another embodiment) asks for her biometrics or password to verify for authorization for deleting or moving the file or email, or forces an acknowledgement read-receipt, sent by the receiver (or by the system, automatically), to the sender, to show to the sender that the email was read or opened or forwarded by the receiver. This can be also done (as one embodiment) with a simple dialog box, and no verification on identity of the user, to just prevent an accidental deleting of an email or file attachment for very important emails or files by the receiver.

In an email system, person A sends an email to person B, and tags that as “Confidential” or “Internal Use, Only”, or has a clause in the email, usually at the bottom, indicating the content as confidential information. In such a case, user/person B's system does not have the permission to forward the email to outside of the company or to an unauthorized recipient or to forward at all (e.g. she cannot send to a person who is not in the list of the authorized people, or to a person who is in the list of forbidden people (as name or email address), or with different email address extensions, different from the company's name, e.g. other than “XXXXXXX@ourcompany.com” address, which is allowed to circulate only within “ourcompany.com” address or domain or server(s)). Authorized recipients could be configured by user B (or the IT department of user B), or it could be based on the recipient's email address (that could only be internal email address). This would prevent accidental or even intentional forwarding to unauthorized recipients.

In one embodiment, the sender is warned about the confidentiality of the email before forwarding the email, by a dialog on screen of computer (with or without the verification of his identity). Then, if the sender says “OK” to the dialog (approves the process), then the email gets forwarded. This prevents (stops) the accidental forwarding of the sensitive information, as one example.

The confidentiality or other privacy designations can be extracted from the subject line, the body of the email, flagged by the previous or original sender as a property of the email, or the confidentiality notices (e.g. usually at the bottom of emails).

The confidentiality notices can be searched and found, in a text file or email text content, using the keywords such as “Confidential” or “private” or “secret” or the like, using word search engines available in the market, or pattern recognition engines to match with a string of characters, such as “Confidential” or “private” or “secret”, character-by-character, one at a time comparison. If the message is just an image (not a text file), then the file is OCR-ed first, using an optical character recognition engine or software or module, to convert that to a text file, so that the analysis above can be performed next.

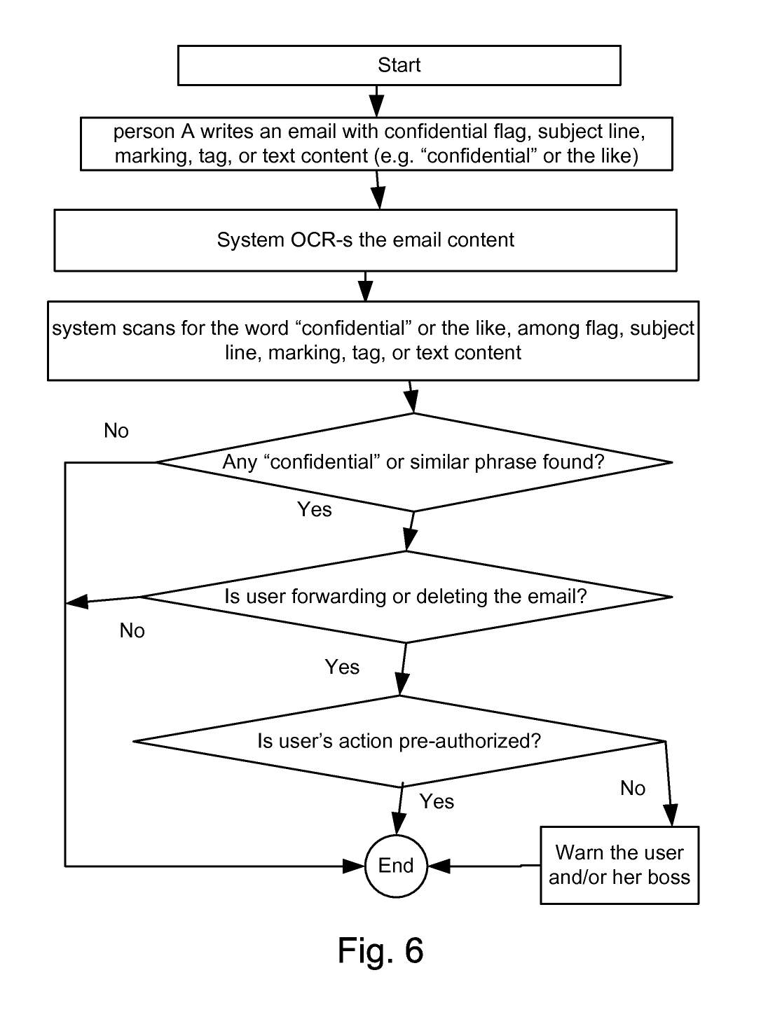

An embodiment for a system finding any confidentiality indications or indicators (e.g. after OCR (optical character recognition) and scan), and then warning the user (or her boss or authorities) automatically (by the system or controller or processor or microprocessor or server or the like) (if the user's action is not pre-authorized, or the forwarding email recipient is not among the approved people or recipients), is shown in FIG. 6.

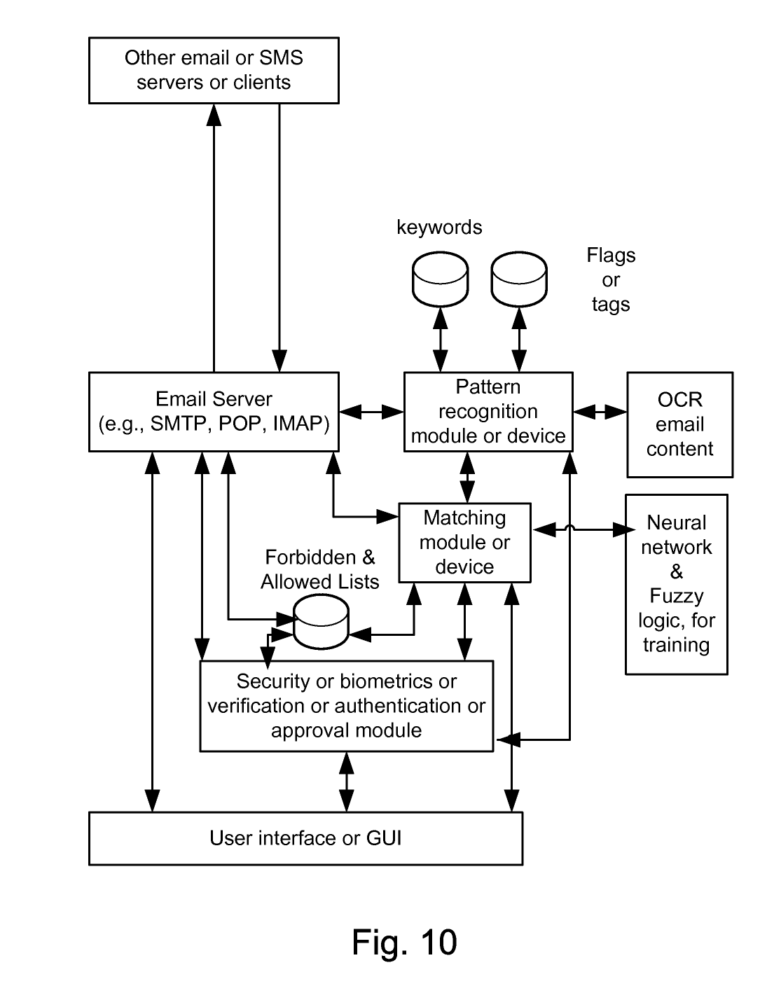

FIG. 10 shows an example of a system in which some email content gets OCR-ed (supplied from the email server (not shown in the figure, to simplify the figure)), and together with some other emails (which are already in text format) go through pattern recognition and matching modules (with optional training module, using neural network and Fuzzy logic modules), to use keywords (e.g. “Confidential” or “private” or “secret”) and flags or tags (e.g. identify the email as confidential, in the header, subject line, or as a flag turned on, as a property of the email), as the indicators, to distinguish the confidential emails (or the like). Then, if the recipients are in the “forbidden list” (or not in the “allowed list”), then the email cannot be sent, from the server. That is, the system does not let the email go to the destination. Of course, there are an optional GUI and an optional security (or biometrics or verification or authentication or just simple approval (with no authentication)) module, which help the user experience and address the security of the system.

### Using Templates:

To make templates for emails, in an email system, person A starts to write a message, starting with a well-known subject line related to some occasion such as “Congratulations!” or “Condolence” or “Happy Valentine” or “Merry Christmas” or “Happy New Year” or “Happy Thanksgiving”, or the like, or on its first line, or in the body of the email. The system immediately provides various options from the person A's prior emails, as templates or guides, to choose from, to write similar email, on screen, to review and choose from. Or, the templates are produced by the system administrator in a database or list, available for usage for free or for a fee, or produced by other users or social community or online friends, to be shared or displayed for others to use, as options. In one embodiment, these templates are written by others, for the use of public, or friends-only, in a social media setting or web site, with allowed connections or accesses, pre-set by the user (with or without authentication or verification or password or the like).

In addition, in one embodiment, the templates are presented to the user automatically, based on the occasion which calendar (associated with the email system) indicates (that is important to remind to the user) (e.g. Christmas day or the days around that period, or days before or on a friend's birthday). So, the trigger is done automatically by the system, for example, for Christmas day, pre-set by the system on all calendars.

The templates or sub-templates can also come from the database on the system, as generic ones, as form paragraphs or templates, to fill up or customize, as a checklist or guide, to help person A write the text and email faster and more accurately. The templates can also contain list or choices of pictures, videos, pre-recorded voices (of famous people or friends or family or person A or person B), movies, games, songs, sound bites, or music pieces, to be chosen by the user or person A, to attach to the email as attachments or files, which are appropriate for the occasion, such as a jingle for a birthday, or template for a format for a legal document (written for and used by a person not familiar with formalities of that type of the letter or message).

For example, the word “Congratulations!” triggers the system to suggest to the user, via a menu or dialog on screen, multiple choices, for different categories, for/corresponding to different templates, e.g.:
“Congratulations—for work/promotion!”
“Congratulations—for a new baby!”
“Congratulations—for a new house!”

Once a category is chosen, the sub-categories are displayed (in a hierarchical structure or choices, to give options or choices for a sub of a subcategory), which can be further customized by the user or person A or by system, e.g. by filling up the gaps and blank spaces in the transcript/text. The text can be added to the body of the email or subject line or as an attachment, e.g. as a text file or music file, e.g. as added voice of the person A on the jingle or music or background, e.g. in karaoke style recording or superimposing of text or sound on the video or background for recording on top of the background, e.g. for birthday music or jingle with different superimposed lyrics, e.g. from famous people/singers, or from familiar people, friends, user, recipient, or family.

In one embodiment, the template looks like a half-filled form, with blanks in-between, as optional for the user to fill in, or get ideas for further content, as suggestions, to guide a user write a letter or message properly, very fast and efficiently, as if an online tutor is helping a user write a letter in a good format and with a proper language for that kind of letter, such as a formal letter to the user's boss requesting a promotion, or an informal letter to a friend who just lost one of his parents, or a letter congratulating a friend for having a new baby, or a letter congratulating a friend for having a second baby, or a letter congratulating a friend for having a first baby girl, or a letter congratulating the boss for having a new baby, each of which have slightly different templates in category or sub-category levels, for ease and convenience of the user, to find and choose them very efficiently/fast, with most of the template already filled up, with minimum work and thinking by the user. The template can suggest sentences and phrases, as well, to make it easier for the user to finish the letter efficiently.

In one embodiment, a template is suggested to the user automatically by the system, after scanning the text of the typical letter or content of email written by the user, automatically highlighting words as variables or placeholders, such as all words that resemble people's names (e.g. words that are not in dictionary, or indicated or flagged as people's names in a generic dictionary associated with the email, or un-recognizable words, or capitalized words), or text strings resembling dates or numbers or addresses or email addresses or telephone numbers, which have a tendency to be different for different email recipients, which require attention or review, by user, to see if they have to be variable for the template.

In one embodiment, a template is suggested to the user, by the system, with all variables highlighted, e.g. with a different color or font or underlined. In one embodiment, the user highlights the section of the text, to become as variables or place holders, to be stored in the system.

The concepts mentioned here in this disclosure can be expanded/are applied to SMS, texting, and MMS, as well.

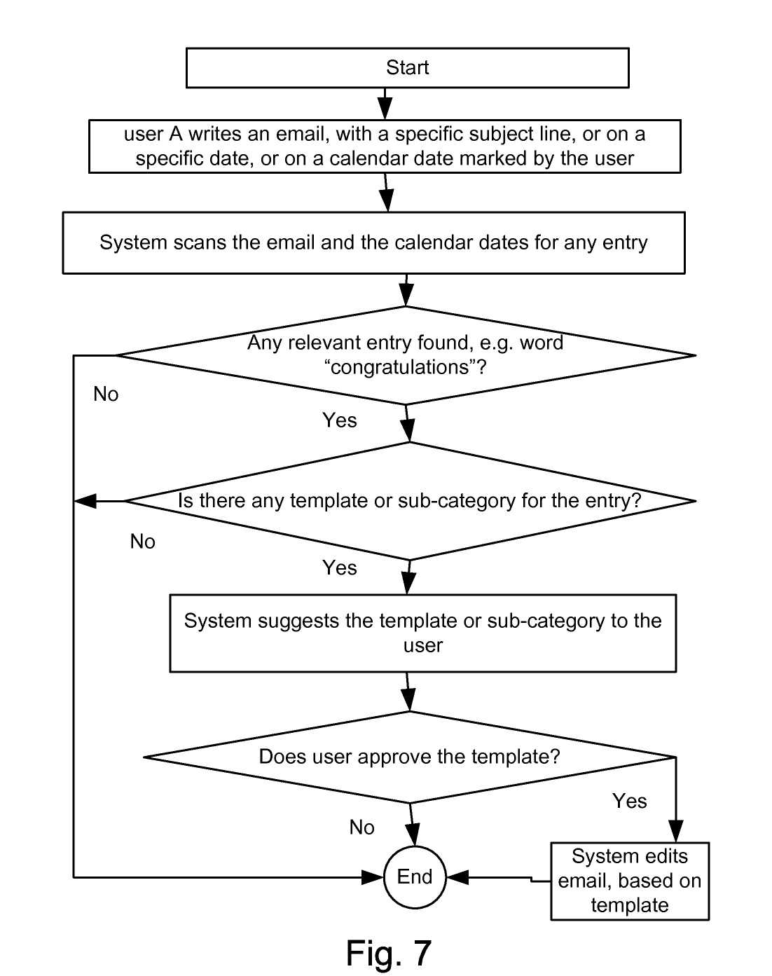

An embodiment for a system finding any relevant entry in the email or calendar, and then suggesting a corresponding template or sub-template (or sub-category) to the user (based on the entry, for replacement or editing, automatically, by the system (pending user's approval of the template or sub-template)), is shown in FIG. 7.

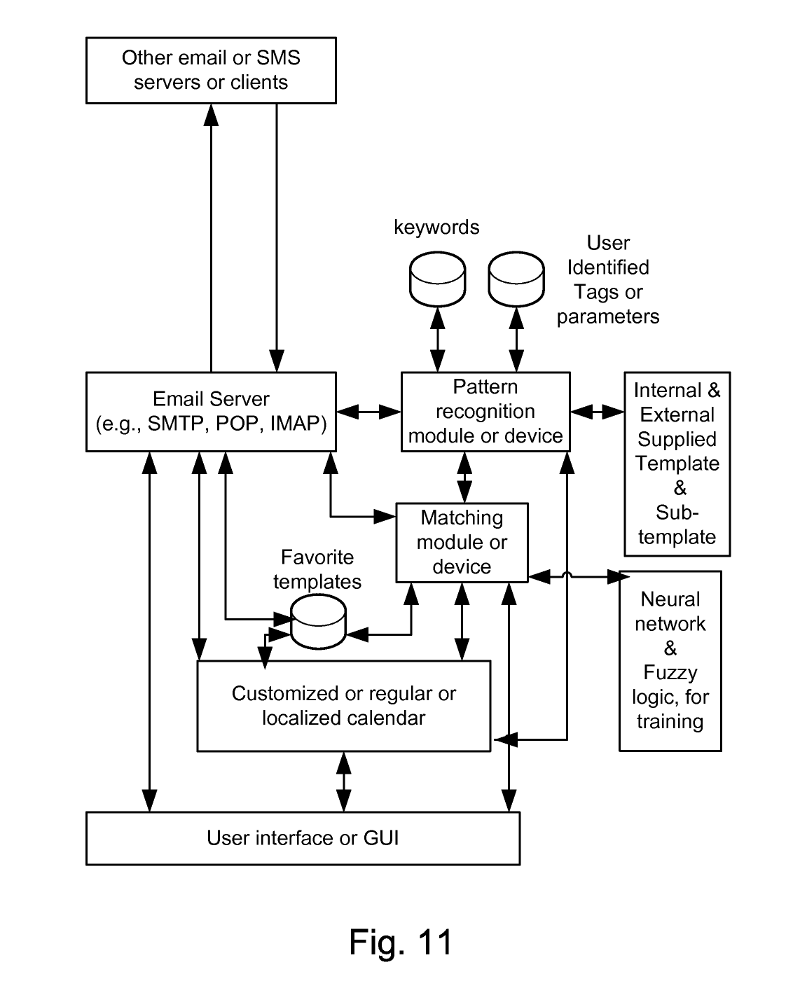

An example of the system is shown in FIG. 11, in which keywords (e.g. the words or phrases such as “Congratulations”) and user-identified tags or parameters (customized per person or user or computer) are used, as indicators, to understand which template or sub-template(s) (sub-category) should be chosen for this particular email (with templates supplied internally or from external sources), with prior favorite templates are automatically (or by the user's choice) stored in the “favorite templates” database. The “favorite templates” database is also connected directly or indirectly (through security module, for example) to the GUI (to the user or administrator) (not shown in the figure, to simplify the figure), to get user's feedback and input. The customized calendar (by the user or class of users), or regular or on-line or device or computer calendar, or localized calendar (per country or region, e.g. having local custom or local or religious holidays or ceremonies or events recorded and captured, e.g. Independence Day or July-4), or a combination of the above can be integrated in this system, for various dates and events, to be used in the email, text searches, template formation, or template choices.

In one example, to set an email list in an email system, person A sends an email to a set of people/list of people. The list can be named to correspond to the context or purpose of the sent email, e.g. “Alumni Club friends”, so that the new group or list of names can be accessed and retrieved very fast and easily, using the name reviews and name lists, in a database, for a future similar email. The name suggestion can be automatic, extracted from the subject line of the email. The name suggestion can be a dialog box, asking the sender or receiver if they want to add or name the new list of people. Or, it can be chosen from a menu choice on the screen/menu.

The matching with prior list or history for the user or set of users on the email system can be exact wording match, or alternatively, can be approximate wording match, as possible or likely suggestion or determination of the new group or list that it belongs to (or should belong to, or is recommended to belong to), using pattern recognition or word matching with spelling or search engines with relevance rating.

To set the default folders for read or selected emails, in an email system, person A reads the email, and then the email is archived or stored in or moved to a proper file or folder in the server or email system, automatically upon opening or closing the email without requiring person A to manually move the email. This is based on predetermined criteria, such as subject line or topic or context, defined by user or administrator, e.g. if the subject title contains the word “alumni”, the email is stored in the “alumni” folder. The system can also figure out the destination file or folder based on previous history of the user moving emails with same criteria to a specific folder.

For example, emails received from any high school friend or emails with subjects that are discussed by high-school friends such as “High school reunion” can automatically move to “high school” folder. Moving to a folder can be silently done or can be done by asking permission from user A via a dialog box that suggests the destination folder, and user A can accept that destination or choose a different destination. However, if the user tries to put that email in a different folder, the system warns the user, and asks for permission to override the prior rule manually, using a dialog box on screen. This feature can be permanently or temporarily disabled or enabled.

To match the folder (or the best fitted folder), the word matching or concept matching is done using pattern recognition or word search or equivalent word search, to assign a relevance score, as how close they are, to be able to assign a folder to an email with some degree of confidence, above a minimum threshold. For example, an email with the subject line “high school reunion” matches very well with all 3 folders named “high school”, “high school reunion”, and “reunion”, with good confidence level (e.g. based on the number/percentage of the number of words matching, e.g. scoring as about 67 percent or (⅔), 100 percent or ( 3/3), and 33 percent or (⅓), respectively, all exceeding e.g. the threshold of 30 percent, as the minimum acceptable range for candidate or target folder). Thus, it can be copied or moved into one, any, or all of them.

Another example is when the phrase “middle school friends” (e.g. in the subject line of an email) is matched with the phrases “old friends” or “childhood friends” or “old buddies” (from various folders, as folder names), based on the similar concepts, based on the equivalency of the following phrases (or basic rules or dictionary or personal dictionary, customized per user for the user):
“friends” being equivalent or referring or relating to “buddies” &
“middle school” being equivalent or referring or relating to “old” or “childhood”.

For example, the regular or generic or customized or specialized dictionaries can be used for this search, as well as a thesaurus, to find or match or score synonyms and antonyms of (or relationship between) words or phrases.

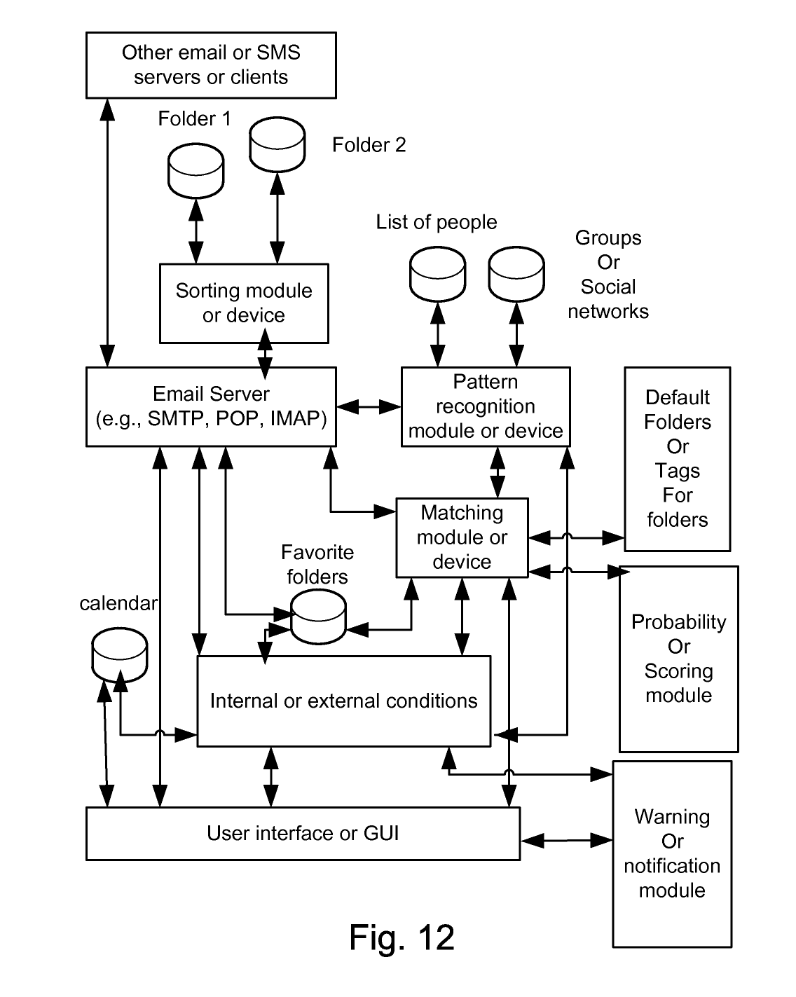

An example of the system is shown in FIG. 12, in which list of people and groups or social networks are examined, to recognize and match the emails to the folders, having default folders (or placeholders for them) and favorite folders (e.g. for most used ones or most likely one(s)), with probability and scoring module (to find the best choice(s)), to be sorted by sorting module into multiple folders, in the email hierarchy or file system or tree structure.

In an email system, consider an example to forward an email automatically, in which person A receives a message from person B. In this embodiment, the system A does (automatically) one of the following 2 functions:
(1) “forward” without keeping a copy, or
(2) “send a copy” and keep a copy of the email.

Such behavior can happen in response to various conditions, such as:
In one embodiment, the “out of office” (for the email of person A) configuration can be the condition of the feature mentioned above, meaning that when the person is out of office, the emails get forwarded automatically to another email address.
In another embodiment, if the email is not read by person A for a certain period of time, then the email gets forwarded to another email address.
In another embodiment, if a previous email from A to B is bounced back and returned, then the returned email gets forwarded to another email address.
In another embodiment, if the email is received in a preconfigured date and time, then email gets forwarded to another email address.
In another embodiment, if the email is received in during public holiday or weekend, then email gets forwarded to another preconfigured email address(es).
In another embodiment, if any email is received from B, then email gets forwarded to another email address.
In another embodiment, for the preconfigured periods of time (such as month of January and July), the emails are forwarded to a first email address, and for December, the emails are forwarded to a second email address, automatically, as pre-set parameters in forwarding email menu.

The calendar for each country or locality may be different in terms of local holidays. So, the individual calendar (personalized or localized) is linked to the system, to provide the dates that are holidays, for which the emails can be forwarded to another email during those dates, for user to access them easier.

For the bounced emails, the header of the bounced email or its tags can be examined by the system, to recognize and filter them as the bounced or rejected emails, so that they can be separated from the rest, so that they get forwarded to another email address, if the user has set it that way.

An example of the system is shown in FIG. 12, in which different actions or various destinations are selected, for the email, based on internal or external conditions, to go or transmit or transfer to different folders (or different servers or devices or computers on the Internet or network).

For sorting and storing the emails, there are 2 options:

(a) When sorting and placing the email in different folders based on multiple criteria, there is only one actual copy of the email in the whole system, and the rest are referring back to the original one as a pointer or placeholder or alias or shortcut, but the other copies do not really exist by themselves.

(b) When sorting and placing the email in different folders based on multiple criteria, there are as many copies of the email as the number of the folders that they are stored in (i.e. more than one copies in the whole system). This way, it requires much bigger space for the storage of the extra copies and the whole email data, but if one deletes or modifies one copy, the other copies are safe and untouched, in other folders, making it more flexible and safer for future work and editing (with built-in redundancies and backups).

In one example, as mentioned above, after opening/closing the email or reading the email, the email can be stored or archived in more than one folder, e.g. as separate and independent copies stored in 2 or more folders. Or, to save space, one copy is stored in one folder, and the other copies are just referring/pointing/shortcutting to that original copy, by pointer or location specification. In one embodiment, it can use a relational database to keep track of these relationships/connections/referrals. In one embodiment, the updating one file has direct updating/initiation effect on all copies of the file, automatically. In another embodiment, the user is asked/prompted (via a dialog box or window) if she is interested to update the other files, as well, as all the copies are previously tagged and located, and can be recalled for inspection or updates or replacement, if needed, based on the user's choice. In one embodiment, the updating of one file only affects that single file copy (or only affects the master copy), with other copies untouched/unmodified.

In one embodiment, the user assigns the folders, and in another embodiment, the system assigns the folders automatically, based on criteria already set, e.g. by the user, e.g. based on subject line and sender's identity, relating to the folders corresponding to the subject and the sender, respectively.

An example of the system is shown in FIG. 12, in which different files or emails are stored or copied or forwarded or edited, based on internal or external conditions, and placed in appropriate folder, or transmitted to proper server or computer or device or client in the network or Internet.

To notify a person about receiving a specific email, in an email system, person A specifies a specific email or topic or sender or subject line or word in the body of email, in advance, for which the system is triggered to notify the user or person A or a third party about the incoming email, using sound, vibration, images, videos, music, voice, or combinations, to alert the user to open and review the email ASAP, which is useful when e.g. during an important meeting, somebody is waiting for an important email, i.e. other emails are not as important, and one specific email cannot be ignored, and must be read/dealt with/responded to, as soon as possible (ASAP).

Please note that all these concepts can be used for SMS, MMS, XMS, texting, emails, or telephone messages, and can notify the user through all methods possible and on any platform, such as calling, emailing, texting, flashing, light, vibration, heat generation, music, notes, sound, or beeping the person, using a phone set, PDA, computer, laptop, IPad, tablet computer, smart phone, GPS, wireless device, pager, walkie-talkie, two-way radios, one-way radios, intercom, broadcasting device, Internet, voice-over-IP, computer network, fiber optic, optical communication device, or other similar devices, or vibrating the phone or other devices, or using the combinations of the above.

An example of the system is shown in FIG. 12, in which once a specific email is received (recognized and matched), by the email server, the system notifies or warns the user by different methods, using the warning or notification module, connected to the GUI or UI (user interface).

In this disclosure, any training on the email system can be done using conventional fuzzy logic and neural network systems. In addition, the pattern recognition and analyzing the content of text or images of the email can be done by any conventional pattern recognition engine (or analyzer) or any search engine available in industry.

Please note that all or some of the features and embodiments above can also be combined in the same email (or texting or telephone or communication or computer or tablet or smart phone) system.

Various memory units, storages, optical storage, magnetic storage, flash drive, memory stick, hard drive, CD, CD-ROM, DVD, disk, disc, RAM, ROM, database, list, table, or the like are used for capturing, storing, comparisons, transferring, recording, and displaying the data and information, in support of the teachings above, connected or within the systems taught or shown here.

The control is done by a CPU, processing unit, processor(s), microprocessor, computer, server, PC, communication device, telephone, smart phone, cell phone, controller, controlling unit, multi-core device, computing module, analyzer, analyzing module or device, entertainment gadget or device or system, or the like, for any of the systems mentioned here (but not shown in figures, to simplify the figures).

Any variations of the teachings in this disclosure are also intended to be covered by this patent application.

1. A method for adjusting email or message recipient list, said method comprising:
receiving an email or message from a user's device or user interface;
distinguishing a first list of recipients from said email or message;
storing said first list of recipients from said email or message in to a first memory device;
classifying device categorizing said email or message into a first group or class based on one or more of following: subject line of said email or message, one or more keywords in content of said email or message, frequency or histogram of one or more words or phrases in content of said email or message, history or patterns of prior emails or messages, time and date of said email or message, a flag or tag corresponding to said email or message, type or content of one or more attachments of said email or message, name of one or more attachments of said email or message, or creator of said email or message;
comparing said first list of recipients with a second list of recipients from emails or messages belonging to said first group or class stored in a second memory device;
if said first list of recipients is different from said second list of recipients from emails or messages belonging to said first group or class, then presenting differences between said first list of recipients and said second list of recipients to said user;
inquiring said user about validity of said differences;
determining said validity of said differences, based on said user's input; and
automatically changing or editing said first list of recipients, based on said validity of said differences and said differences.

2. The method for adjusting email or message recipient list as recited in claim 1, said method comprising: a first analyzing device performing statistical analysis.

3. The method for adjusting email or message recipient list as recited in claim 1, said method comprising: a second analyzing device performing pattern recognition.

4. The method for adjusting email or message recipient list as recited in claim 1, said method comprising: customizing a calendar, based on dates related to locality, personal dates, important events, public dates, or dates associated with friends or social group.

5. The method for adjusting email or message recipient list as recited in claim 1, said method comprising: accessing a calendar for marked dates.

6. The method for adjusting email or message recipient list as recited in claim 1, said method comprising: training module employing neural network and fuzzy logic modules.

7. The method for adjusting email or message recipient list as recited in claim 1, wherein changing or editing said first list of recipients comprises addition or deletion of names or addresses.

8. The method for adjusting email or message recipient list as recited in claim 1, wherein said user's device or user interface comprises security, verification, confirmation, biometrics, sign-up, or authentication module.

9. The method for adjusting email or message recipient list as recited in claim 1, said method comprising: warning or notifying said user.

10. The method for adjusting email or message recipient list as recited in claim 1, said method comprising: displaying a dialog box on display or monitor for said user.

11. The method for adjusting email or message recipient list as recited in claim 1, said method comprising: giving multiple choices to said user, through dialog box or menu.

12. The method for adjusting email or message recipient list as recited in claim 1, said method comprising: calculating a score or probability for matching.

13. The method for adjusting email or message recipient list as recited in claim 1, said method comprising: training a matching module, based on prior matches, samples, and decisions.

14. The method for adjusting email or message recipient list as recited in claim 1, wherein said email or message is one of following: email, Short Message Service, Multimedia Messaging Service, Extended Messaging Service, texting, multimedia message, video message, combination message, live messaging, instant message, or chat session.

15. The method for adjusting email or message recipient list as recited in claim 1, wherein said user's device or user interface is, or is a part of, a computer, personal digital assistant, tablet computer, phone, smart phone, electronic device, game device, e-book reader, game console, communication device, computing device, personal computer, server, terminal, kiosk, video game, entertainment device, multimedia device, movie player, or calendar device.

16. The method for adjusting email or message recipient list as recited in claim 1, said method comprising: warning said user that said first list of recipients is missing one or more names or addresses.

17. The method for adjusting email or message recipient list as recited in claim 1, said method comprising: warning said user that said first list of recipients has one or more extra names or addresses.

18. The method for adjusting email or message recipient list as recited in claim 1, said method comprising: storing samples in training storage or database.

19. The method for adjusting email or message recipient list as recited in claim 1, said method comprising: combining one or more calendars in to one aggregate calendar.

20. The method for adjusting email or message recipient list as recited in claim 1, said method comprising: comparing said first list of recipients with a forbidden recipient database, to prevent said email or message to reach a wrong person.
